(19) United States
(12) Patent Application Publication
(10) Pub. No.: US 2004/0115345 A1
(43) Pub. Date: Jun. 17, 2004

(54) Nanoparticle fractionation and size determination

(76) Inventors: Xueying Huang, Hockessin, DE (US); Ming Zheng, Hockessin, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/622,889

(22) Filed: Jul. 17, 2003

Related U.S. Application Data
(60) Provisional application No. 60/397,819, filed on Jul. 23, 2002.

(51) Int. Cl. B05D 7/00

(52) U.S. Cl. 427/212

(57) ABSTRACT

A novel method for fractionating stabilized, water-soluble nanoparticles based upon the size of the nanoparticles was discovered. For stabilized, charged, water-soluble nanoparticles, the method comprises the addition of a substantially water-miscible organic solvent to an aqueous nanoparticle solution in the presence of an electrolyte. Moreover, a method for determining the average particle size of stabilized, charged, water-soluble nanoparticles using gel electrophoresis was discovered.

This application claims the benefit of U.S. Provisional Application No. 60/397,819, filed Jul. 23, 2002.

### FIELD OF THE INVENTION

The present invention relates to the field of nanoscale materials. More specifically, the invention provides methods for the size fractionation and size determination of nanoparticles.

### BACKGROUND OF THE INVENTION

Nanoparticles are nanometer-sized metallic and semiconducting particles that have recently been the subject of extensive research in the field of nanoscale materials. Nanoparticles have potential applications in many diverse fields. These applications include: nanoscale electronic devices, multifunctional catalysts, chemical sensors, and many biological applications such as biosensors, biological assays, transfection of organisms using gene-gun technology, and drug delivery (Niemeyer, Angew. Chem. Int. Ed. 40:4128-4158 (2001)).

Nanoparticles can be prepared readily in large quantities by relatively simple methods and have properties that are very different from the corresponding bulk material. Stabilizers, such as various organic coatings, are required to prevent particle aggregation and to make the particles soluble in various solvents. Recently, water-soluble gold nanoparticles, stabilized by monolayers of tiopronin or coenzyme A, have been reported (Templeton et al., Langmuir 15:66-76 (1999)). The average particle size of these particles could be systematically controlled by varying the mole ratio of tiopronin or coenzyme A to tetrachloroauric acid used in the reaction. Moreover, it has been demonstrated that these nanoparticles can be functionalized with a wide variety of structural units using relatively simple chemistry (Templeton et al., J. Am. Chem. Soc. 121:7081-7089 (1999)).

The physical and chemical properties of nanoparticles are critically dependent on their size. Many applications require monodispersed nanoparticles, i.e., particles of uniform size, with a defined particle size. However, chemical synthesis usually results in nanoparticles with a broad particle size distribution, i.e., polydispersed nanoparticles. Methods are known in the art for determining the size of nanoparticles and for separating nanoparticles based on their size.

Transmission electron microscopy (TEM) is generally employed to determine the particle size distribution and the average particle size of nanoparticles. However, this method is time consuming and requires expensive instrumentation. Moreover, TEM does not provide any separation process. A simpler, faster method is needed to determine the average particle size of nanoparticles.

Size exclusion chromatography (SEC) has been used to characterize and separate gold nanoparticles. For example, Wei et al. (J. Chromatogr. A 836, 253-260 (1999)) described the separation of gold nanoparticles between 5 and 38 nm in size using SEC with a polymer-based column of 100 nm pore size. In that work, the surfactant sodium dodecyl sulfate was added to the mobile phase to reduce the sorption of particles by the packing materials, a common problem in the SEC separation of nanoparticies. The shape separation of gold nanoparticles using SEC has also been described (Wei et al., Anal Chem. 71:2085-2091 (1999)). SEC has the potential to generate nanoparticles with a narrow size distribution from a polydispersed sample with fractional collection. However, SEC is applicable to the fractionation of only relatively small amounts of nanoparticles and is time consuming.

Gel electrophoresis and capillary electrophoresis have also been applied to separate nanoparticles. Schaaff et al. (J. Phys Chem. 102:10643-10646 (1998)) described the isolation of a gold cluster compound using polyacrylamide gel electrophoresis (PAGE). In order to collect the separated fractions, the bands had to be cut out of the gel and the nanoparticles extracted. Colloidal gold particles have been characterized according to size using capillary zone electrophoresis (CE) (Schnabel et al., J. Microcolumn Separations 9:529-534 (1997)). However, fraction collection with CE is problematic and limited to very small volumes by the nature of the technique. Neither of these disclosures teaches the use of electrophoresis to determine the average particle size of stabilized, water-soluble nanoparticles.

Whetten et al. (Adv. Mater. 8:428-433 (1996)) described a simple method for fractionating gold nanoparticles from organic solvents by incremental addition of a non-solvent. However, they do not suggest how this method could be applied to stabilized, water-soluble nanoparticles.

Subramaniam et al. in U.S. Pat. No. 6,113,795 described a process and apparatus for the separation of nanoparticles from organic solvents. This process utilizes a filter or separator to separate particles that are precipitated from an organic solvent by the addition of a supercritical antisolvent, such as supercritical carbon dioxide. The application of this process to the separation of stabilized, water-soluble nanoparticles was not taught.

The need exists for a simple, fast and inexpensive method to fractionate stabilized, water-soluble nanoparticles based on size. Additionally, the need exists for a simple and inexpensive means for determining the average particle size of stabilized, water-soluble nanoparticles.

Applicants have solved the stated problem by the discovery that the addition of an organic solvent to an aqueous solution of stabilized nanoparticles having a broad size distribution will result in the precipitation and fractionation of a population of nanopartilces having a narrow size distribution.

### SUMMARY OF THE INVENTION

The invention relates to a method for the size fractionation of stabilized, charged, water-soluble nanoparticles by adding a substantially water-miscible organic solvent to a population of nanoparticles dissolved in an aqueous solution containing an electrolyte. Additionally, the invention relates to a method for the size determination of stabilized, charged, water-soluble nanoparticles using gel electrophoresis.

Thus the invention provides a method for generating a population of nanoparticles having a narrow size distribution comprising:

a) providing a population of stabilized, charged, water-soluble, nanoparticles having a broad size distribution;

b) dissolving the stabilized, charged, water-soluble, nanoparticles in an aqueous solution containing an electrolyte;

c) adding a substantially water-miscible organic solvent to the dissolved nanoparticles of (b) whereby a certain size fraction of the nanoparticles are precipitated; and

d) collecting the nanoparticle precipitate of step (c) having a narrow size distribution.

Additionally the invention provides a method for determining the average size of stabilized, charged, water-soluble nanoparticles comprising:

a) providing a population of charged, water-soluble nanoparticles of unknown size in an aqueous solution in combination with a densifying agent;

b) providing a solution of stabilized, charged, water-soluble nanoparticle size standards of known size in combination with a densifying agent;

c) loading the nanoparticles of (a) and (b) on to an electrophoresis gel;

d) separating the loaded nanoparticles of (c) by applying an electric field to the gel; and

e) determining the average size of the unknown nanoparticles by comparing their mobility in the gel with the mobility of the nanoparticles size standards.

In another preferred embodiment the invention provides a method for fractionating stabilized, charged, water-soluble nanoparticles based upon the size of the nanoparticles and determining the average particle size of the resulting fractions comprising:

(a) fractionating the stabilized, charged, water-soluble nanoparticles according to the method of the invention and

(b) determining the average particle size of the fractions according to the method of the invention.

Additionally the invention provides a method for fractionating stabilized, charged, water-soluble nanoparticles based upon the size of the nanoparticles and determining the average particle size of the resulting fractions comprising:

(a) fractionating the stabilized, charged, water-soluble nanoparticles according to the method of the invention; and

(b) determining the average particle size of the fractions using transmission electron microscopy.

### BRIEF DESCRIPTION OF THE FIGURES

FIG. 1 is the electrophoresis gel image showing the particle size determination of glutathione monolayer-protected gold nanoparticles.

FIG. 2 is the electrophoresis gel image showing the analysis of fractionated glutathione monolayer-protected gold nanoparticles.

FIG. 3A shows the transmission electron microscopy results for the size distribution of the initial, unfractionated glutathione monolayer-protected gold nanoparticles.

FIG. 3B shows the transmission electron microscopy results for the size distribution of fraction 6 of the fractionated glutathione monolayer-protected gold nanoparticles.

FIG. 4 is the electrophoresis gel image showing the analysis of fractionated tiopronin monolayer-protected gold nanoparticles.

### DETAILED DESCRIPTION OF THE INVENTION

The present invention is based on the discovery that charged, water-soluble nanoparticles, having a broad size distribution in solution may be fractionated by the regulated addition of an organic solvent. The invention relates to nanoparticles that have been coated with a stabilizing monolayer that additionally conveys water solubility. Additionally the invention provides a method to determine the size of the fractionated nanoparticles by separation by gel electrophoresis.

Nanoparticles have utility in the field of nanoscale electronic devices, multifunctional catalysts, chemical sensors, and many biological applications such as biosensors and biological assays. The construction of many of these nanomaterials requires that the size of the nanoparticle be relative uniform and that the size be known. The present invention addresses this need in the art by providing a facile method for fractionating nanoparticles into fractions having a narrow size distribution as well as a method for determining the size of the nanoparticles in those fractions.

A number of abbreviations and definitions are used throughout this disclosure and may be used for the interpretation of the claims and the specification.

“A₅₂₀” means the optical density measured at 520 nm.

“CE” refers to capillary electrophoresis.

“g” means grams.

“GSH” refers to the chemical compound glutathione.

“h” means hours.

“kV” means kilovolts.

“min” means minutes.

“mg” means milligrams.

“mM” means millimoles per liter.

“mL” means milliliters.

“nm” means nanometers.

“PAGE” means polyacrylamide gel electrophoresis.

“rpm” means revolutions per minute.

“SEC” means size exclusion chromatography.

“TEM” means transmission electron microscopy.

“μL” means microliters.

“μM” means micromoles per liter.

“V” means volts.

“Nanoparticles” are herein defined as metallic or semiconductor particles with an average particle diameter of between 1 and 100 nm. Preferably, the average particle diameter of the particles is between about 1 and 40 nm. As used herein, “particle size” and “particle diameter” have the same meaning. The metallic nanoparticles include, but are not limited to, particles of gold, silver, platinum, palladium, iridium, rhodium, osmium, iron, copper, cobalt, and alloys composed of these metals. An “alloy” is herein defined as a homogeneous mixture of two or more metals. The “semiconductor nanoparticles” include, but are not limited to, particles of cadmium selenide, cadmium sulfide, silver sulfide, cadmium sulfide, zinc sulfide, zinc selenide, lead sulfide, gallium arsenide, silicon, tin oxide, iron oxide, and indium phosphide.

The nanoparticles are stabilized and made water-soluble by the use of a suitable organic coating or monolayer. As used herein, monolayer-protected nanoparticles are one type of stabilized nanoparticle. Methods for the preparation of stabilized, water-soluble metal and semiconductor nanoparticles are known in the art. These particles can be either charged or neutral depending on the nature of the organic coating. For example, Templeton et al. (Langmuir 15:66-76 (1999)), herein incorporated by reference, describe a method for the preparation of stabilized, charged, water-soluble gold nanoparticles protected by tiopronin or coenzyme A monolayers. To prepare the tiopronin-protected gold nanoparticles, tetrachloroauric acid and N-(2-mercaptopropionyl)glycine (tiopronin) were codissolved in a mixture of methanol and acetic acid. Sodium borohydride was added with rapid stirring. The average particle size of these particles could be controlled by varying the mole ratio of tiopronin to tetrachloroauric acid in the reaction. The coenzyme A protected gold nanoparticles were prepared in a similar manner by substituting coenzyme A for tiopronin in the reaction.

A similar method of preparing stabilized, water-soluble nanoparticles of the metals gold, silver, platinum, palladium, cobalt and nickel is descried by Heath et al. in U.S. Pat. No. 6,103,868, herein incorporated by reference. In this method, a solution or dispersion of one or more metal salts was mixed with a solution of an organic surface passivant that had a functional group such as a thiol, phosphine, disulfide, amine, oxide, or amide. A reducing agent was then added to reduce the metal salt to the free metal.

A method for preparing stabilized, water soluble platinum nanoparticles is described by Chen et al. (Colloids and Surfaces A 169:107-116 (2000)), herein incorporated by reference. These nanoparticles were prepared in an ethanol-water mixture by the reduction of chloroplatinic acid by ethanol in the presence of poly(N-vinylisobutyramide).

Hagemeyer et al. in U.S. Pat. No. 6,074,979, herein incorporated by reference, described a method for preparing polybetaine-stabilized palladium nanoparticles by reacting a palladium salt, such as palladium acetate, with a reducing agent, such as sodium borohydride, in the presence of a polybetaine.

Stabilized, neutral, water-soluble metal nanoparticles are prepared using the methods described above using a nonionic stabilizing organic coating or monolayer. For example, Wuelfing et al. (J. Am. Chem. Soc. 120:12696-12697 (1998)), herein incorporated by reference, described the preparation of neutral, water-soluble gold nanoparticles protected by a monolayer of thiolated poly(ethylene glycol).

Stabilized, charged, water soluble semiconductor nanoparticles can also be produced by various known methods. For example, Chan et al. (Science 281:2016-2018 (1998)), herein incorporated by reference, described a method for preparing zinc sulfide-capped cadmium arsenide nanoparticles by reacting the nanoparticles with mercaptoacetic acid in chloroform. Another method for preparing stabilized, charged, water-soluble semiconductor nanoparticles is described by Mitchell et al. (J. Am. Chem. Soc. 121:8122-8123 (1999)), herein incorporated by reference. In this method, cadmium selenide/zinc sulfide nanoparticles were coated with a mixture of trioctylphosphine oxide and trioctylphosphine. These nanoparticles were then reacted with excess 3-mercaptopropionic acid in dimethyl formamide to form propionic acid-functionalized nanoparticles.

Stabilized, neutral, water-soluble semiconductor nanoparticles can be prepared by coating the particles with a nonionic organic stabilizing compound, such as poly(ethylene oxide) or poly(vinyl alcohol), as described by Napper (J. Colloid. Interface. Sci 58:390-407 (1977)).

For both stabilized, water-soluble semiconductor and metal nanoparticles it is possible to use mixtures of various stabilizing coatings or monolayers, for example, poly(ethylene glycol) and glutathione or poly(ethylene glycol) and tiopronin.

In one embodiment of the present invention, stabilized, charged, water-soluble nanoparticles having a broad size distribution are fractionated based upon the size of the nanoparticles by adding a substantially water-miscible organic solvent in the presence of an electrolyte. As used herein a “broad size distribution” in reference to a population of nanoparticles will refer to nanoparticles ranging in size from about 1 nm to about 100 nm, wherein the majority of nanoparticles are spread over a large range of particle sizes. A fraction of nanoparticles having a “narrow size distribution” will be a fraction where nanoparticles within the average particle size range, make up at least about 30% of the population, wherein at least about 40% of the population is preferred, wherein at least about 50% of the population is more preferred and wherein at least about 60% to about 100% of the population is most preferred.

A substantially water-miscible organic solvent is herein defined as an organic solvent that dissolves completely in water up to a concentration of at least 80% by volume. Suitable organic solvents include, but are not limited to, methanol, ethanol, isopropanol, dimethyl sulfoxide, tetrahydrofuran, dimethylformamide, dioxane, and acetone. Suitable organic solvents also include mixtures of organic solvents that are completely miscible with each other and that result in a mixture which is a substantially water-miscible organic solvent. Examples of mixed solvents include, but are not limited to, ethyl acetate and methanol; ethyl acetate and ethanol; ethyl acetate and isopropanol; ethyl acetate and acetone; ethyl acetate, dimethylformamide and dimethyl sulfoxide; and ethyl acetate, tetrahydrofuran, and dioxane. The preferred organic solvent is methanol or ethanol. The electrolytes that can be used include, but are not limited to, sodium chloride, sodium phosphate, sodium citrate, sodium acetate, magnesium sulfate, calcium chloride, ammonium chloride, and ammonium sulfate. The divalent metal ion salts appear to work better with nanoparticles that are stabilized with mixed coatings, such as poly(ethylene glycol) and glutathione, than with nanoparticles that are stabilized with single component coatings. The preferred electrolyte is sodium chloride.

In order to fractionate the stabilized, charged, water-soluble nanoparticles, the particles are first dissolved in an aqueous electrolyte solution having an electrolyte concentration of about 10 to 500 mM. Then, an addition of the substantially water-miscible organic solvent is made. The amount of the substantially water-miscible organic solvent added depends on the average particle size desired. The appropriate amount can be determined by routine experimentation. Typically, the substantially water-miscible organic solvent is added to give a concentration of about 5% to 10% by volume to precipitate out the largest particles. The nanoparticles are collected by centrifugation or filtration. Centrifugation is typically done using a centrifuge, such as a Sorvall® RT7 PLUS centrifuge available from Kendro Laboratory Products (Newtown, Conn.), for about 1 min at about 4,000 rpm. For filtration, a porous membrane with a pore size small enough to collect the nanoparticle size of interest can be used.

Optionally, sequential additions of the substantially water-miscible organic solvent are made to the nanoparticle solution to increase the solvent content of the solution and therefore, precipitate out nanoparticles of smaller sizes. The number of additions and the volume of the additions depend on the desired size distribution of the nanoparticles and can be determined by routine experimentation. Typically, additions of the substantially water-miscible organic solvent are made to increase the solvent content of the nanoparticle solution by about 5-15% by volume with each addition, up to a solvent concentration of about 70% by volume, which is sufficient to precipitate the smallest particles. The nanoparticles are collected after each addition as described above and the subsequent additions of the substantially water-miscible organic solvent are made to the supernatant. The collected nanoparticles are redissolved in water and the particle size distribution of the fractions can be determined using transmission electron microscopy (TEM), as described by Templeton et al. (Langmuir 15:66-76 (1999)). The average particle size of the fractions can be determined using the gel electrophoresis method described below.

In another embodiment of the present invention, the average particle size of the stabilized, charged, water-soluble nanoparticles is determined using gel electrophoresis. This method can also be applied to the determination of the average particle size of stabilized, neutral, water-soluble nanoparticles after the particles have been functionalized with ionic groups to make them charged. Gel electrophoresis is a commonly used method in biochemistry and molecular biology to separate macromolecules such as proteins and nucleic acids. The gel serves as a sieving medium to separate the macromolecules on the basis of size. In the present invention, the gel can be made from agarose or polyacrylamide. Methods for preparing suitable gels are well known and exemplified in Sambrook, J., Fritsch, E. F. and Maniatis, T. Molecular Cloning: A Laboratory Manual, Second Edition, Cold Spring Harbor Laboratory Press, Cold Spring Harbor (1989), particularly Chapter 6 (entirely incorporated herein by reference). Suitable agarose gels have an agarose concentration between 0.6 and 6% (weight per volume), while suitable polyacrylamide gels have an acrylamide concentration between 3.5 and 20% (weight per volume). It is well know in the art that the concentration of the gel to be used depends on the size of the molecules being separated. Specifically, higher gel concentrations provide better separation for smaller molecules, while lower gel concentrations are used to separate larger molecules. The gel concentration to be used for a given nanoparticle fractionation can be determined by routine experimentation. The preferred gel of the present invention is a 4% agarose gel.

In order to determine the average particle size of stabilized, charged, water-soluble nanoparticles, a densifying agent is added to an aqueous solution of the nanoparticles. The purpose of densifying agent is to increase the specific gravity of the nanoparticle solution to facilitate loading of the solution into the gel. Suitable densifying agents are well known and include, but are not limited to, glycerol, sucrose, and Ficoll® (a nonionic, synthetic polymer of sucrose, approximate molecular weight of 400,000, available from Sigma, St. Louis, Mo.). The stabilized, charged, water-soluble nanoparticle solution is then added to the wells in the gel. In order to determine the average particle size of stabilized, charged, water-soluble nanoparticles using gel electrophoresis, nanoparticle size standards are required. Stabilized, charged, water-soluble nanoparticle size standards can be prepared by numerous methods. For example in one method, stabilized, charged, water-soluble nanoparticles are prepared, fractionated and the average particle size of the fractions is determined using TEM, as described above. These fractions can then serve as the size standards. In another method, commercially available monodispersed colloidal gold nanoparticles with different and known average particle sizes are coated with a stabilizing organic layer, as described above, and used as size standards. The stabilized, charged, water-soluble nanoparticle size standards are loaded into at least one well on the gel and the electrophoretic separation is carried-out by applying an electric field across the gel. The voltage used and the time of separation required to separate the nanoparticles can be determined by routine experimentation. As shown in Example 5, a voltage of 90 V with a separation time of 90 min gave good separation of glutathione monolayer-protected gold nanoparticle fractions. The average particle size of the unknown stabilized, charged, water-soluble nanoparticles is determined by comparing the mobility of these particles to that of the stabilized, charged, water-soluble nanoparticle size standards. The comparison can be made visually or by using a commercial gel imaging system, such as the HP ScanJet 6300C scanner available from Agilent Technologies (Wilmington, Del.) or the Gel Doc 1000 System, in conjunction with image analysis software, such as Multi-Analyst, both available from Bio-Rad Laboratories (Hercules, Calif.).

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### Example 1

### Particle Size Fractionation of Glutathione Monolayer-Protected Gold Nanoparticles

The purpose of this Example was to demonstrate the size fractionation of glutathione (GSH) monolayer-protected gold nanoparticles from an aqueous solution. The method comprises the fractional precipitation of the stabilized, charged, water-soluble nanoparticles by addition of a substantially water-miscible organic solvent in the presence of an electrolyte.

Preparation of Glutathione Monolayer-Protected Gold Nanoparticles

Unless otherwise noted, all reagents were purchased from Aldrich (Milwaukee, Wis.) and were used without further purification. In a typical reaction, 60 mL of methanol (HPLC grade) and 10 mL of acetic acid (HPLC grade) were mixed in an Erlenmeyer flask by stirring for 2-5 min. Tetrachloroauric acid (HAuCl₄.xH₂O, 99.99%) (0.37 g) and 61.4 mg of glutathione (GSH) (99% minimum, obtained from Sigma, St. Louis, Mo.) were added to the above mixed solvents and dissolved by stirring for 5 min, resulting in a clear, yellow solution. A sodium borohydride solution was prepared by dissolving 0.6 g of NaBH₄ (99%) in 30 g of Nanopure® water. The NaBH₄ solution was added dropwise into the above solution with rapid stirring. When the first drop of NaBH₄ solution was added, the HAuCl₄ solution immediately turned dark brown from yellow. This reaction was exothermic, warming the solution for approximately 15 min. During the reaction, the pH of the solution changed from 1.2 to about 5.0. The reaction solution was stirred rapidly for 2 h. The glutathione monolayer-protected gold nanoparticles were soluble in water and when diluted, the solution became clear purple.

This preparation method results in nanoparticles with a broad size distribution.

Fractionation of Glutathione Monolayer-Protected Gold Nanoparticles

The GSH monolayer-protected gold nanoparticles (0.3 g) were dissolved in 50 mL of a 100 mM sodium chloride solution. The first fraction of the nanoparticles was precipitated out by adding methanol to the nanoparticle solution to a final content of 14% by volume. The nanoparticles were collected by centrifugation at 4000 rpm for 1 min in a Sorvall® RT7 PLUS centrifuge (Kendro Laboratory Products, Newtown, Conn.). Then, more methanol was added to the supernatant to a final content of 18% by volume and the precipitated nanoparticles were collected as described above as the second fraction. This step-wise addition of methanol was continued and nanoparticle fractions 3-7 were collected at methanol concentrations of 22%, 26%, 30%, 34% and 38% by volume, respectively.

### Example 2

### Particle Size Fractionation of Tiopronin Monolayer-Protected Gold Nanoparticles

The purpose of this Example was to demonstrate the size fractionation of tiopronin monolayer-protected gold nanoparticles from an aqueous solution. The method comprises the fractional precipitation of the stabilized, charged, water-soluble nanoparticles by addition of a substantially water-miscible organic solvent in the presence of an electrolyte.

Tiopronin monolayer-protected gold nanoparticles were prepared as described in Example 1, except that 16.32 mg of N-(2-mercaptopropionyl)glycine (tiopronin) was substituted for GSH. The nanoparticles were fractionated by the addition of methanol, as described in Example 1. Fractions 1 and 2 were collected after the addition of 10% and 20% by volume methanol, respectively.

### Example 3

### Particle Size Fractionation of Glutathione Monolayer-Protected Gold Nanoparticles Using Other Solvents and Electrolytes

The purpose of this Example was to demonstrate the effectiveness of other substantially water-miscible organic solvents and electrolytes in the fractionation of GSH monolayer-protected gold nanoparticles.

The GSH monolayer-protected gold nanoparticles were prepared and fractionated as described in Example 1, except that other substantially water-miscible organic solvents and electrolytes were used. The substantially water-miscible organic solvents that were tested included: ethanol, isopropanol, and acetone. The electrolytes tested included: sodium phosphate, sodium citrate, sodium acetate, ammonium chloride, and ammonium sulfate.

All the substantially water-miscible organic solvents and electrolytes tested worked well for the fractionation of GSH monolayer-protected gold nanoparticles.

### Example 4

### Particle Size Determination of Glutathione Monolayer-Protected Gold Nanoparticles Using Gel Electrophoresis

The purpose of this Example was to demonstrate the determination of the average particle size of fractionated glutathione monolayer-protected gold nanoparticles using gel electrophoresis.

Preparation of Glutathione Monolayer-Protected Gold Nanoparticle Size Standards

Monodispersed, colloidal gold nanoparticles (at a concentration of approximately 0.75 A₅₂₀ units/mL) with sizes of 5, 10, and 20 nm were purchased from Sigma (St. Louis, Mo.). The GSH monolayer-protected gold nanoparticle size standards were prepared by mixing 200 μL of each of the colloidal gold samples with 10 μL of a 10 mM GSH solution (pH=7.4) and incubating overnight at room temperature.

Determination of Average Particle Size using Gel Electrophoresis

Ten microliters of fraction 6 of the fractionated glutathione monolayer-protected gold nanoparticles from Example 1, at a concentration of about 10 μM, was mixed with 2 μL of 50% glycerol, and loaded onto a 4% agarose/Tris-Borate-EDTA (TBE) gel (BioWhittaker, Rockland, Me.). The size standards were loaded onto the gel in a similar manner. The gel was immersed in 1×TBE running buffer (89 mM Tris, 89 mM boric acid, 2 mM EDTA, pH=8.3), and electrophoresis was carried out at a constant voltage of 90 V for 90 min in a Horizon 58 gel box (Life Technologies, Rockville, Md.). The gel image was recorded using an HP ScanJet 6300C scanner (Agilent Technologies, Wilmington, Del.).

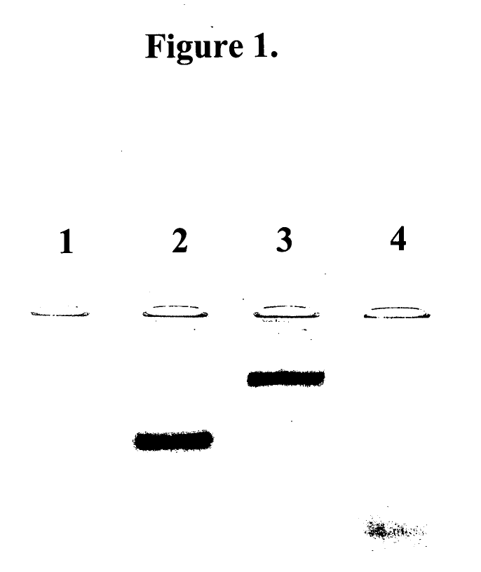

The gel image resulting from this experiment is shown in FIG. 1. In the Figure, lanes 1, 2 and 3 are GSH monolayer-protected gold nanoparticle standards with particle sizes of 5, 10 and 20 nm respectively. Lane 4 is the GSH monolayer-protected gold nanoparticle fraction 6 from 10 Example 1. Based on the its mobility compared to the standards, the average particle size of the sample was estimated to be between 3 and 4 nm. The average particle size of the fraction 6 nanoparticles was also determined using transmission electron microscopy (TEM) with an electron voltage of 200 kV and a 500K magnification using a JEOL-2011 transmission electron microscope. The average particle size was found to be 3.5 nm, in excellent agreement with the electrophoresis results.

### Example 5

### Analysis of Fractionated Glutathione Monolayer-Protected Gold Nanoparticles

The purpose of this Example was to analyze the fractions of GSH monolayer-protected gold nanoparticles prepared in Example 1 using gel electrophoresis and TEM.

The fractionated GSH monolayer protected gold nanoparticles from Example 1 were analyzed using the electrophoresis method described in Example 4. The nanoparticle fractions 1-7 were loaded on the gel along with the initial, unfractionated GSH monolayer-protected gold nanoparticle sample, which served as a comparison.

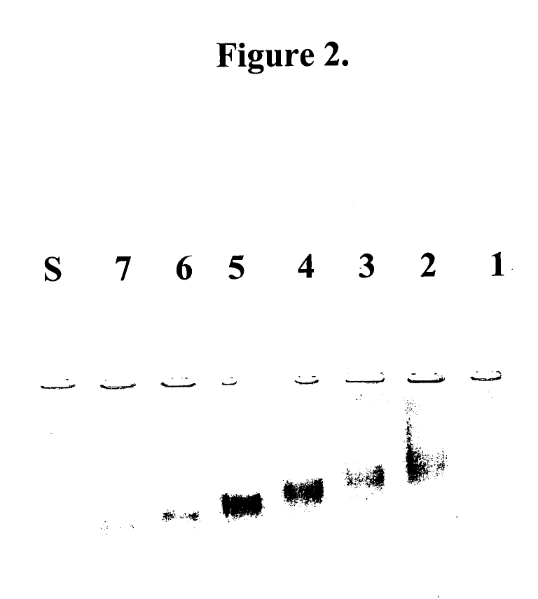

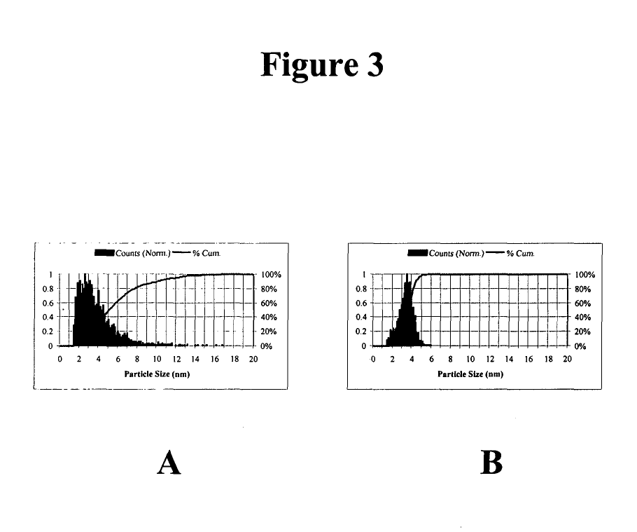

The image of the resulting gel is shown in FIG. 2. In the Figure, “S” represents the initial, unfractionated sample, and the numbers refer to the fraction number. Gel electrophoresis of all the fractions collected demonstrated that by gradually increasing the methanol content of the mixed solvent, nanoparticles of decreasing size were precipitated out, as evidenced by the increasing mobility observed for fractions 1 through 7. We also observed a gradual change of color from one fraction to the next, consistent with the well-known effect of particle size on surface plasmon resonance absorption. Quantitative TEM analysis of the initial product (FIG. 3A) and fraction 6 (FIG. 3B) confirmed that the size distribution was greatly narrowed by the fractionation method described in Example 1.

### Example 6

### Analysis of Fractionated Tiopronin Monolayer-Protected Gold Nanoparticles

The purpose of this Example was to analyze the fractions of tiopronin monolayer protected gold nanoparticles prepared in Example 2 using gel electrophoresis.

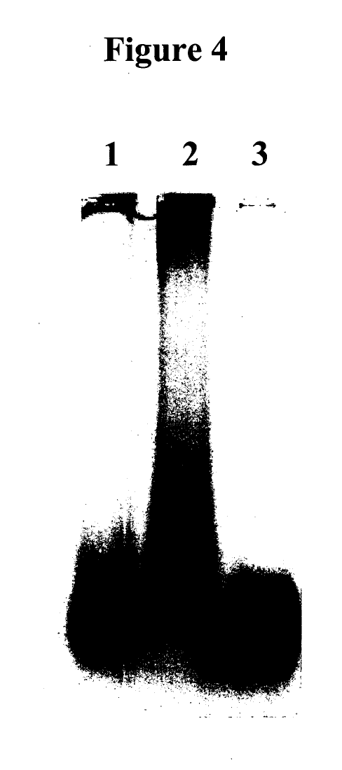

The tiopronin monolayer-protected gold nanoparticle fractions from Example 2 were analyzed by gel electrophoresis, as described in Example 4 and as shown in FIG. 4, similar results were obtained. In FIG. 4, lane 1 is the initial, unfractionated sample, lane 2 is the first fraction collected with 10% by volume methanol added, and lane 3 is the second fraction collected with 20% by volume methanol added.

What is claimed is:

1. A method for generating a population of nanoparticles having a narrow size distribution comprising:
a) providing a population of stabilized, charged, water-soluble, nanoparticles having a broad size distribution;
b) dissolving the stabilized, charged, water-soluble, nanoparticles in an aqueous solution containing an electrolyte;
c) adding a substantially water-miscible organic solvent to the dissolved nanoparticles of (b) whereby a certain size fraction of the nanoparticles are precipitated; and
d) collecting the nanoparticle precipitate of step (c) having a narrow size distribution.

2. A method according to claim 1 wherein steps (c) and (d) are optionally repeated at least once to increase the substantially water-miscible organic solvent content of nanoparticle solution and to collect nanoparticle fractions having different narrow size distributions.

3. A method according to claim 1 wherein the nanoparticles are coated with a monolayer.

4. A method according to claim 3 wherein the monolayer coating is selected from the group consisting of tiopronin, glutathione, coenzyme A, poly(ethylene glycol), poly(ethylene oxide), and poly(vinyl alcohol).

5. A method according to claim 1 wherein the nanoparticles are metal nanoparticles

6. A method according to claim 5 wherein the metal nanoparticles are comprised of metals selected from the group consisting of gold, silver, platinum, palladium, and copper nanoparticles, and alloys thereof.

7. A method according to claim 6 wherein the nanoparticles are comprised of gold.

8. A method according to claim 1 wherein the nanoparticles are semiconductor nanoparticles

9. A method according to claim 8 wherein the semiconductor nanoparticles are comprised of materials selected from the group consisting of cadmium selenide, cadmium sulfide, silver sulfide, cadmium sulfide, zinc sulfide, zinc selenide, lead sulfide, gallium arsenide, silicon, tin oxide, iron oxide and indium phosphide.

10. A method according to claim 1 wherein the nanoparticles are about 100 nm or less in diameter

11. A method according to claim 1 wherein the nanoparticles are about 40 nm or less in diameter.

12. A method according to claim 1 wherein the electrolyte is selected from the group consisting of sodium chloride, sodium phosphate, sodium citrate, sodium acetate, magnesium sulfate, calcium chloride, ammonium chloride, and ammonium sulfate.

13. A method according to claim 12 wherein the electrolyte is sodium chloride.

14. A method according to claim 1 wherein the substantially water-miscible organic solvent is selected from the group consisting of methanol, ethanol, isopropanol, dimethyl sulfoxide, tetrahydrofuran, dimethylformamide, dioxane and acetone.

15. A method according to claim 14 wherein the substantially water-miscible organic solvent is methanol or ethanol.

16. A method according to claim 1 wherein the substantially water-miscible organic solvent is a mixture of organic solvents.

17. A method according to claim 16 wherein the mixture of organic solvents are combinations selected from the group consisting of ethyl acetate and methanol; ethyl acetate and ethanol; ethyl acetate and isopropanol; ethyl acetate and acetone; ethyl acetate, dimethylformamide, and dimethyl sulfoxide; and ethyl acetate, tetrahydrofuran, and dioxane.

18. A method according to claim 1 wherein the nanoparticles are collected by centrifugation or filtration.

19. A method for determining the average size of stabilized, charged, water-soluble nanoparticles comprising:
a) providing a population of charged, water-soluble nanoparticles of unknown size in an aqueous solution in combination with a densifying agent;
b) providing a solution of stabilized, charged, water-soluble nanoparticle size standards of known size in combination with a densifying agent;
c) loading the nanoparticles of (a) and (b) on to an electrophoresis gel;
d) separating the loaded nanoparticles of (c) by applying an electric field to the gel; and
e) determining the average size of the unknown nanoparticles by comparing their mobility in the gel with the mobility of the nanoparticles size standards.

20. A method according to claim 19 wherein the densifying agent is selected from the group consisting of glycerol, sucrose and Ficoll®.

21. A method according to claim 19 wherein the gel is comprised of agarose or polyacrylamide.

22. A method according to claim 19 wherein the gel is an agarose gel having an agarose concentration of about 0.6% to about 7%.

23. A method according to claim 22 wherein the gel is a 4% agarose gel.

24. A method according to claim 19 wherein the gel is a polyacrylamide gel having an acrylamide concentration of about 3.5% to about 21%.

25. A method according to claim 19 wherein the nanoparticles are metal nanoparticles.

26. A method according to claim 19 wherein the nanoparticles are about 100 nm or less in diameter.

27. A method for fractionating stabilized, charged, water-soluble nanoparticles of a specified size comprising:
(a) fractionating the stabilized, charged, water-soluble nanoparticles according to the method of claim 1; and
(b) determining the average particle size of the fractions according to the method of claim 19.

28. A method for fractionating stabilized, charged, water-soluble nanoparticles of a specified size comprising:
(a) fractionating the stabilized, charged water-soluble nanoparticles according to the method of claim 1; and
(b) determining the average particle size of the fractions using transmission electron microscopy.

29. A population of nanoparticles fractionated by the method of claim 1.

30. A population of nanoparticles having a narrow size distribution.
